(19) United States
(12) Patent Application Publication
(10) Pub. No.: US 2026/0002806 A1
(43) Pub. Date: Jan. 1, 2026

(54) THERMAL FLOW SENSOR FOR DETERMINING A FLOW RATE OF A FLUID

(71) Applicant: Berkin B.V., Ruurlo (NL)

(72) Inventors: Shirin Azadi KENARI, Ruurlo (NL); Joost Conrad LÖTTERS, Ruurlo (NL); Remco Gerardus Petrus SANDERS, Ruurlo (NL); Remco John WIEGERINK, Ruurlo (NL)

(21) Appl. No.: 19/144,865

(22) PCT Filed: Jan. 2, 2024
(86) PCT No.: PCT/NL2024/050001

§ 371 Date: Jun. 30, 2025

(30) Foreign Application Priority Data
Jan. 2, 2023 (NL) 2033894

(51) Int. Cl. G01F 1/684; G01F 1/69; G01F 1/696; G01N 25/18

(52) U.S. Cl. CPC G01F 1/6845; G01F 1/69; G01F 1/696; G01N 25/18

(57) ABSTRACT

The invention relates to a thermal flow sensor (2) for determining a flow rate of a fluid (1), comprising:
a sensor body (11) with a flow section (12), through which fluid flows (3) in a flow direction during use,
a flow sensor configuration (13), comprising multiple flow sensing elements (14), such as two or three, arranged at multiple locations in the flow section for measuring the flow velocity at different locations in the flow section,
wherein the multiple flow sensing elements (14) are arranged parallel to each other in a plane parallel to the flow section, and wherein single flow sensing elements (14) of the multiple flow sensing elements (14) can be read out.

### FIELD OF THE INVENTION

The present invention generally relates to a thermal flow sensor for determining a flow rate of a fluid.

### BACKGROUND OF THE INVENTION

Thermal flow sensors are used to measure the flow rate of both gases and liquids. There are mainly three types of thermal flow sensors: anemometric, calorimetric and time-of-flight.

All three mentioned thermal flow sensor types are typically composed of a heater and temperature sensors; and follow a similar working principle, i.e., supplying power to the heater to elevate the temperature, and then measuring the change in temperature distribution over the sensor structure as a measure for the flow rate. Variations are possible, such as where power is kept constant and heaters also serving as temperature sensors.

Thermal flow sensors have a simple working principle and relatively low fabrication cost. In addition, they are suitable for adaptation in microelectromechanical (MEMS) devices. However, they are dependent on the type of the flowing medium, more specifically the thermal properties of the gas or liquid. It means calibration of these sensors is required whenever the medium changes.

Another technique is to measure the thermal conductivity by decreasing the dependency of the wire temperature on flow using different structures or implementing the sensor in a dead volume.

DE 4224518 A discloses a flow sensor that includes a silicon body which has temperature sensitive resistance structures for anemometers in gas analysers. The resistance structures are mounted at least on the edges of the sensor regions on dielectric supporting structures. The two sensor regions are joined by a channel for the fluid. Single sensors cross the flow channel multiple times.

However, this technique is only suitable for flow sensors inside micromachined channels, i.e. it does not work in larger tubes.

### OBJECT OF THE INVENTION

It is therefore an object of the invention to provide a thermal flow sensor that can be used to measure the flow rate in a larger tube. In addition, it is an object of the invention to increase speed of such sensors, and to provide a bidirectional flow sensor.

### SUMMARY OF THE INVENTION

The invention provides a thermal flow sensor for determining a flow rate of a fluid, comprising:
a sensor body with a flow section, through which fluid flows in a flow direction during use,
a flow sensor configuration, comprising multiple flow sensing elements, such as two, three, four or more flow sensing elements, arranged at multiple locations in the flow section for measuring the flow velocity at different locations in the flow section,
wherein the multiple flow sensing elements are arranged parallel to each other in a plane parallel to the flow section, such as a plane coinciding with the flow section, and wherein single flow sensing elements of the multiple flow sensing elements can be read out.

By having multiple flow sensing elements for measuring the flow velocity at different locations in the flow section, measuring the flow rate in a larger tube, such as a tube used with ventilation, for instance medical ventilation, is advantageously made possible. Furthermore, measuring or observing the flow profile is also made possible. Differences in sensitivity between the multiple flow sensing elements can be utilized to make flow profiles or to extend the range by selecting a single flow sensing element to be read out.

In the context of the present patent application, “essentially stationary” means that the fluid basically “stands still”, but a relatively small degree of diffusion and movement of fluid particles in the measurement cavity is allowable, and even necessary to reflect changing fluid composition. It is found this is possible without interfering with the accuracy of the measurement.

The flow sensing elements should be strong enough to withstand the fluid pressures associated to the intended flow range.

An embodiment relates to an aforementioned thermal flow sensor, wherein the sensor body comprises:
a main body portion;
a first body portion extending from the main body portion;
a second body portion extending from the main body portion;
wherein the flow section is formed between the main body portion, the first body portion and the second body portion.

An embodiment relates to an aforementioned thermal flow sensor, wherein the first body portion and the second body portion are parallel to each other.

An embodiment relates to an aforementioned thermal flow sensor, wherein the multiple flow sensing elements extend between the first body portion and the second body portion.

An embodiment relates to an aforementioned thermal flow sensor, wherein the flow section has a square or rectangular shape in a plane transversal to the flow direction.

An embodiment relates to an aforementioned thermal flow sensor, wherein the multiple parallel flow sensing elements are spaced-apart in the flow section in an even manner.

An embodiment relates to an aforementioned thermal flow sensor,
wherein the multiple flow sensing elements comprise two, three, four, five or more flow sensing elements.

An embodiment relates to an aforementioned thermal flow sensor, wherein each flow sensing element comprises a pair of flow sensing wires, or a combination of three flow sensing wires.

An embodiment relates to an aforementioned thermal property sensor, wherein the wire has a cross-section of under 10 μm, such as about 9 μm, about 8 μm, 7 μm, about 6 μm, 5 μm, about 4 μm, 3 μm, about 2 μm, or about 1 μm.

An embodiment relates to an aforementioned thermal property sensor, wherein the wire is silicon (Si) or silicon oxide or silicon nitride or another silicon compound.

An embodiment relates to an aforementioned thermal property sensor, wherein the wire has a cross-section that is flattened on one side, such as a square shape, a triangular shape, a semi-circular shape, or, most preferably a rectangular shape. The flat part of the flattened cross-section preferably has a width of under 10 μm, such as about 9 μm, about 8 μm, 7 μm, about 6 μm, 5 μm, about 4 μm, 3 μm, about 2 μm, or about 1 μm. In addition the cross-section preferably has a thickness of 0.1-1 μm, depending on the robustness of the material and the conditions. The small volume of the sensor allows for extremely high speed. This has been estimated for silicon, where the time constant scales linearly with the volume, thus reducing the volume by half will increase the speed of a sensor about 2 times if all other variables remain the same. A response that is twice as fast would be desirable in the field of flow sensors, and even larger increases are possible by reducing the volume by more than half. Alternatively, sets of probes, such as comprising platinum may be used instead of flow sensing wires, or a set of wires may be replaced by probes to combine wires and probes.

The flow sensing wires should preferably be as thin as possible—e.g. having cross-sections as mentioned in the foregoing—the use of e.g. carbon nanotubes is also conceivable.

An embodiment relates to an aforementioned thermal flow sensor, wherein the flow sensing wires of the pair of flow sensing wires or the combination of three flow sensing wires are spaced-apart in the flow direction.

An embodiment relates to an aforementioned thermal flow sensor, wherein the sensor body is a microelectromechanical device.

An embodiment relates to an aforementioned thermal flow sensor, wherein the flow sensor configuration is an integrated part of the sensor body.

An embodiment relates to an aforementioned thermal flow sensor, wherein the pairs of flow sensing wires are arranged parallel to each other.

A mutual distance between the pairs of flow sensing wires is 300-500 μm, preferably 350-450 μm, more preferably 375-425 μm.

A mutual distance between the pairs of flow sensing wires may also be between ⅓ and 1/20 of a diameter of a flow tube in which the thermal flow sensor is placed, such as between ¼ and 1/20, for instance between ⅕ and 1/20, of the diameter of the flow tube.

An embodiment relates to an aforementioned thermal flow sensor, wherein each of the one or more pairs of flow sensing wires forms a Wheatstone Bridge or part (such as a half) of a Wheatstone bridge.

Fixed resistors may be arranged on the sensor body to form the other part (such as the other half) of the Wheatstone bridge.

An embodiment relates to an aforementioned thermal flow sensor, comprising:
a measurement cavity for receiving a portion of the fluid, in such a way, that the portion of the fluid is essentially stationary in the measurement cavity, with a thermal property sensor comprising a heating wire configured for being heated with:
a constant current (DC) or very low frequency alternating current (AC), for heating the portion of the fluid, wherein the voltage of the heating wire during the heating of the portion of the fluid is measured with voltage measurement means connected to the heating wire, wherein the measured voltage is related to a thermal conductivity; and/or
a high frequency alternating current (AC), wherein a phase and amplitude of the third harmonic of the alternating current (AC) voltage of the heating wire during the heating of the portion of the fluid are measured with voltage measurement means connected to the heating wire, wherein the measured phase and amplitude of the third harmonic of the measured AC voltage are related to a heat capacity.

An embodiment relates to an aforementioned thermal flow sensor, wherein the measurement cavity has a U- or V-shaped cross-section, wherein the heating wire is suspended in the measurement cavity with the U- or V-shaped cross-section.

An embodiment relates to an aforementioned thermal flow sensor, wherein the measurement cavity with the U- or V-shaped cross-section has a length of 1-3 mm and a width (W_{groove}) of 20-60 μm. The V-shape may be slightly knotted or have other imperfections.

An embodiment relates to an aforementioned thermal flow sensor, wherein the thermal flow sensor is releasably inserted into a flow channel in which a fluid flow is present during use.

Another aspect of the invention concerns a method for determining a flow rate of a fluid independent of the thermal properties of the fluid comprising:
placing an aforementioned thermal flow sensor in a fluid flow;
placing a thermal property sensor in a measurement cavity in fluid connection with, and preferably adjacent to, the fluid flow;
receiving a portion of the fluid in the measurement cavity of the thermal property sensor, in such a way, that the portion of the fluid is essentially stationary in the measurement cavity;
measuring at least one thermal property (κ, pCₚ) of the fluid; and
compensating the measured flow rate for the at least one measured-thermal property.

Another aspect of the invention concerns a method for determining a thermal conductivity (κ) and/or a heat capacity (cₚ) of a fluid, whose flow is to be determined, comprising:
placing an aforementioned thermal flow sensor in a fluid flow and measuring flow;
placing a thermal property sensor in a measurement cavity in fluid connection with, and preferably adjacent to, the fluid flow;
receiving the portion of the fluid in the measurement cavity of the thermal property sensor, in such a way, that the portion of the fluid is essentially stationary in the measurement cavity,
heating a heating wire of the thermal property sensor with a constant current (DC) or very low frequency alternating current (AC), for heating the portion of the fluid, and
measuring the voltage of the heating wire during the heating of the portion of the fluid with voltage measurement means connected to the heating wire and relating the measured voltage to a thermal conductivity; and/or
heating the heating wire of the thermal property sensor with a high frequency alternating current (AC); and
measuring a phase and amplitude of the third harmonic of the measured alternating current (AC) voltage of the heating wire during the heating of the portion of the fluid with voltage measurement means (9) connected to the heating wire and relating the measured phase and amplitude of the third harmonic of the measured AC voltage to a heat capacity.

Another aspect of the invention concerns a thermal flow meter or controller, comprising an aforementioned thermal flow sensor.

Another aspect of the invention relates to a use of such a thermal flow meter or controller in a medical device, in particular a respiratory device.

In yet another embodiment, at least one of the wires could be heated with a different current than the other wires, thus heating the wires to different temperatures. This allows the characterization of fluids at different temperatures.

Another aspect of the invention concerns a method for producing an aforementioned thermal flow sensor, comprising the steps of:
(1) depositing a support layer at both sides of a wafer,
(2) depositing a metal layer on one side of the wafer,
(3) patterning the metal layer,
(4) patterning the support layer to open windows for etching the Si underneath,
(5) repeating steps 2 to 4 on the other side of the wafer,
(6) etching the Si wafer to realize a U- or V-groove and a flow sensing element cavity inside the wafer.

An embodiment relates to an aforementioned production method, wherein:
(4) the support layer is etched to open the window for etching the Si wafer underneath.

An embodiment relates to an aforementioned production method, wherein the metal layer comprises a Cr/Pt layer.

An embodiment relates to an aforementioned production method, wherein the support layer is an SiRN support layer.

An embodiment relates to an aforementioned method, wherein:
(1) the support layer has a thickness of 1 μm.

An embodiment relates to an aforementioned method, wherein:
(2) the layer of Cr/Pt has a thickness of 20 nm/200 nm,

An embodiment relates to an aforementioned method, wherein:
(3) patterning the support layer comprises etching of the Cr/Pt layer,

An embodiment relates to an aforementioned method, wherein:
(2) the layer of Cr/Pt is deposited by sputtering.

In an embodiment, Step 1 uses Low Pressure Chemical Vapor deposition (LPCVD).

In an embodiment, Step 6 uses KOH for the etching, preferably 1:3 in distilled water.

### BRIEF DESCRIPTION OF THE DRAWINGS

The invention will be explained by means of the exemplary embodiments depicted in the accompanying drawings and the detailed description of the Figures below.

FIG. 1 shows a perspective view of an example embodiment of a thermal flow sensor;

FIG. 2 shows a perspective view of an example embodiment of a thermal property sensor with a measurement cavity;

FIG. 3 shows an example embodiment of a heating wire of a thermal property sensor connected to voltage measurement means;

FIG. 4 shows a cross-section of an example embodiment of a hating wire arranged in a measurement cavity with a U- or V-shaped cross-section;

FIG. 5 shows a circuit schematic of a Wheatstone bridge;

FIG. 6 shows fabrication steps for fabricating a U- or V-shaped measurement cavity with a heating wire arranged therein; and

FIG. 7 shows another example embodiment of a flow channel with a thermal flow sensor and a thermal property sensor.

### DETAILED DESCRIPTION

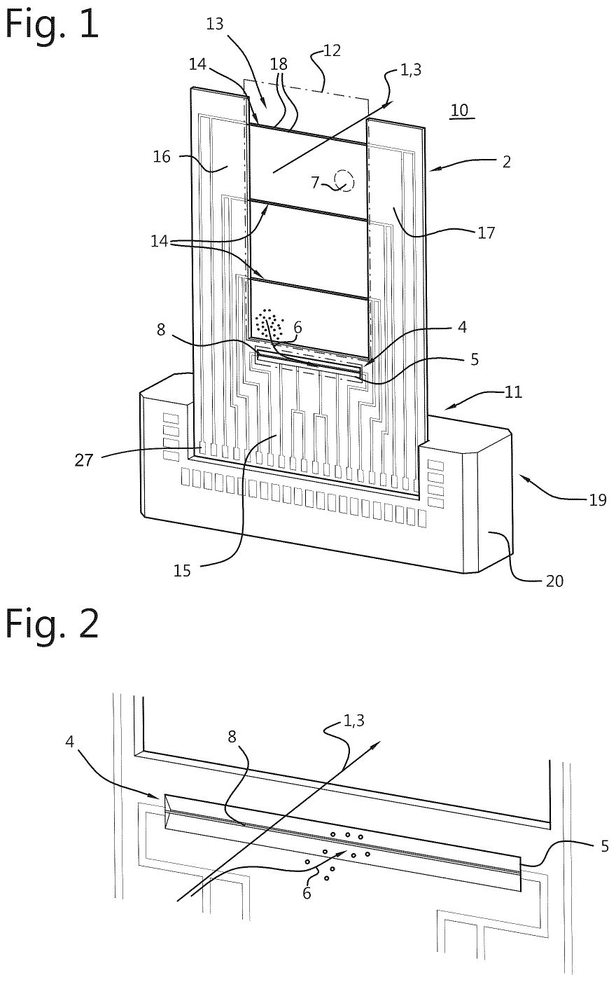

FIG. 1 shows a perspective view of an example embodiment of a thermal flow sensor 2 for measuring a fluid flow 3, in particular a laminar fluid flow 3, comprising a measurement cavity 5 in fluid connection with, and preferably adjacent to, the fluid flow 3. The measurement cavity 5 is comprised by a thermal property sensor 4. A heating wire 8 is placed in the measurement cavity 5 for receiving a portion 6 of the fluid, in such a way, that the portion 6 of the fluid is essentially stationary in the measurement cavity 5. The thermal flow sensor 2 may be releasably inserted into a flow channel 10 in which a fluid flow 3 is present during use.

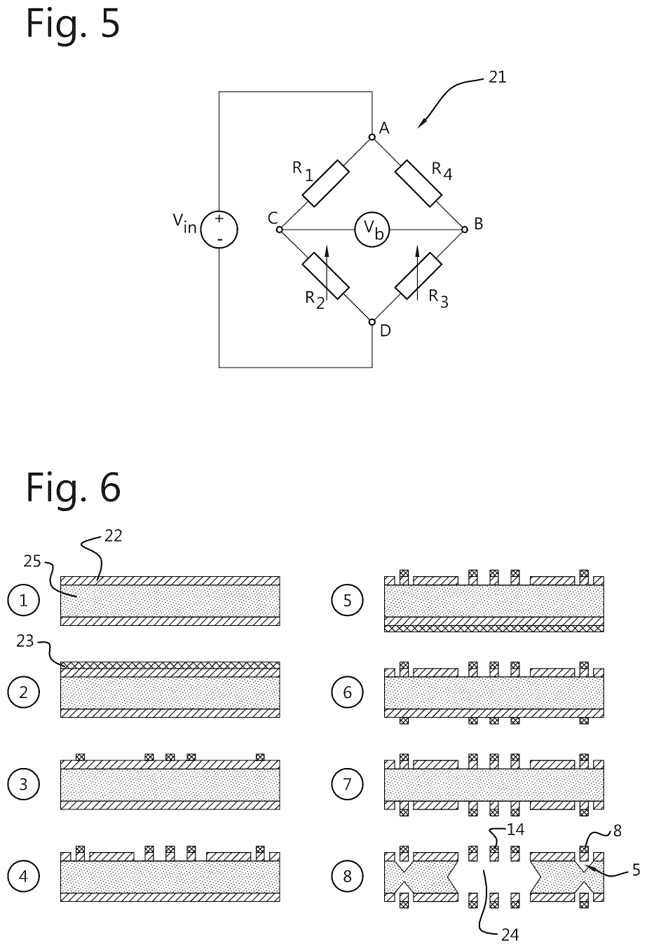

The thermal flow sensor 2 may comprise a sensor body 11 with a flow section 12, through which the fluid 1, of which a flow rate is to be determined, flows in a flow direction during use. In line with the invention, a flow sensor configuration 13 may be provided, comprising multiple flow sensing elements 14 arranged at multiple locations in the flow section 12. The thermal flow sensor 2 may comprise a main body portion 15, a first body portion 16 extending from the main body portion 15 and a second body portion 17 extending from the main body portion 15. The flow section 12 may be formed between the main body portion 15, the first body portion 16 and the second body portion 17. The measurement cavity 5 may be arranged in the main body portion 15. The main body portion 15 contains a multitude of bond pads 27 for reading out the data generated by the multiple flow sensing elements 14. Both ends of the multiple flow sensing elements 14 are connected to individual bonding pads 27 to facilitate separate read-out of each single sensing element 14, which, of course, can be done concurrently. The measurement cavity 5 may extend along a side of the flow section 12. The flow sensor configuration 13 may comprise multiple flow sensing elements 14 arranged at multiple locations in the flow section 12, such as three, as shown in FIG. 1. The flow section 12 may be open at a side of the flow section 12 not delimited by the main body portion 15, the first body portion 16 and/or the second body portion 17. The first body portion 16 and the second body portion 17 may be parallel to each other. The flow section 12 may have a square or rectangular shape in a plane transversal to the flow 3 direction. The multiple flow sensing elements 14 may extend between the first body portion 16 and the second body portion 17. The multiple flow sensing elements 14 can be spaced-apart in the flow section 12 in an even manner. Each flow sensing element 14 may comprise a pair of flow sensing wires 18. A mutual distance between the pairs of flow sensing wires 18 may be 300-500 μm, preferably 350-450 μm, more preferably 375-425 μm. The pairs of flow sensing wires 18 of the thermal flow sensor 2 may extend between the first body portion 16 and the second body portion 17. The sensor body 11 may be formed as a chip 19. The sensor body 11 may be attached to, or arranged on, a printed circuit board (PCB) 20. Each of the one or more pairs of flow sensing wires 18 may form one half (R₂, R₃) of a Wheatstone bridge 21, as shown in FIG. 5. Each individual wire 18 in the pair or triplet of wires 18 can be read-out separately. This also can be done concurrently as is visualized in FIG. 1 showing the bond pads 27 for the separate connections. The skilled person will understand that the arrow shown through R₃ should point downwards in case a differential flow signal is to be measured. Fixed resistors R₁, R₄ arranged on the sensor body 11 may form the other half of the Wheatstone bridge 21. The thermal flow sensor 2 may be a microelectromechanical system (MEMS) component. In no-flow condition, R₁ and R₄ and R₂ and R₃ have the same value, so the output signal of the Wheatstone bridge 21 is zero. When flow is applied, heat will be transferred from an upstream wire to a downstream one. Therefore, there will be a positive or negative (depending on the flow direction) output voltage signal as a result of the temperature difference between the two wires R₂ and R₃.

FIG. 2 shows a perspective view of an example embodiment of a thermal property sensor 4 with a measurement cavity 5 in more detail.

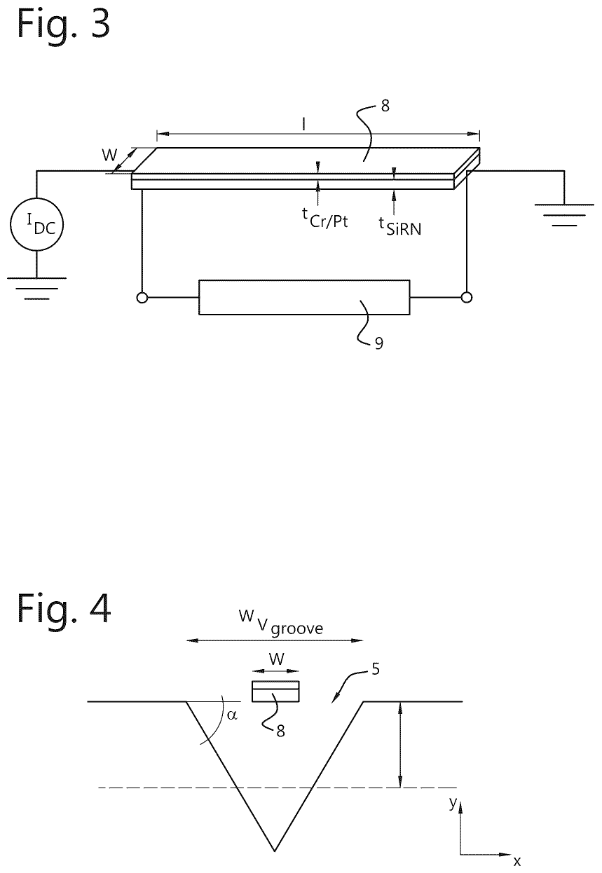

As more clearly shown in FIG. 3, the heating wire 8 may be configured for being heated with a constant current (DC) or very low frequency alternating current (AC), for heating the portion 6 of the fluid 1, wherein the voltage of the heating wire 8 during the heating of the portion 6 of the fluid is measured with voltage measurement means 9 connected to the heating wire 8, wherein the measured voltage is related to a thermal conductivity κ; and/or an alternating current (AC), wherein a phase and amplitude of the third harmonic of the alternating current (AC) voltage of the heating wire 8 during the heating of the portion 6 of the fluid 1 are measured with voltage measurement means 9 connected to the heating wire 8, wherein the measured phase and amplitude of the third harmonic of the measured AC voltage are related to a heat capacity cₚ.

As shown in FIG. 4, the measurement cavity 5 may have a U- or V-shaped cross-section, wherein the heating wire 8 is suspended in the measurement cavity 5 with the U- or V-shaped cross-section. The measurement cavity 5 with the U- or V-shaped cross-section may have a length/of 1-3 mm and a width (W_{groove}) of 20-60 μm in a MEMS embodiment. The temperature of the heating wire 8 is dominated by the thermal conductivity κ of the fluid/gas 6 inside the measurement cavity 5 and largely independent of the fluid flow 3 velocity. Hence, by monitoring the voltage drop over the heating wire 8 at constant heating current, κ can be detected. The angle α as shown in FIG. 4 may be 50-60 degrees.

A method for determining a flow rate of a fluid 1 independent of the thermal properties of the fluid 1 is also provided, comprising:
contacting a thermal flow sensor 2 to a fluid flow 3;
measuring a flow rate;
placing a thermal property sensor 4 in a measurement cavity 5 in fluid connection with, and preferably adjacent to, the fluid flow 3;
receiving a portion 6 of the fluid in the measurement cavity 5 of the thermal property sensor 4, in such a way, that the portion 6 of the fluid is essentially stationary in the measurement cavity 5;
measuring at least one thermal property (κ, ρcp) of the fluid 1; and
compensating the measured flow rate for the at least one measured thermal property.

The method may further comprise:
using the thermal flow sensor 2 in the fluid flow 3 to additionally measure at least one thermal property.

The thermal property measured in the fluid flow 3 may be heat capacity (cₚ) or density (φ.

The thermal property measured on the essentially stationary fluid 6 is thermal conductivity (κ).

A highly schematically indicated pressure sensor 7 may additionally measure pressure and/or a pressure differential to derive viscosity from the thermal property and the measured pressure and/or pressure differential.

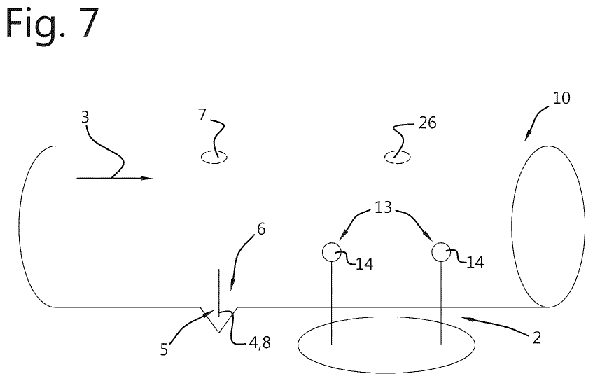

A highly schematically indicated additional sensor 26, such as shown in FIG. 7, may be added to the device. The additional sensor 26 may be a viscosity sensor, (external) humidity sensor, CO₂ sensor, (external) temperature sensor, dielectric or permittivity sensor, fluid composition sensor or multiparameter sensor.

The thermal conductivity (κ) can be measured by:
heating the heating wire 8 with a constant current (DC) or very low frequency alternating current (AC), for heating the portion 6 of the fluid 1, and
measuring a voltage of the heating wire 8 during the heating of the portion 6 of the fluid with voltage measurement means 9 connected to the heating wire 8 and relating the measured voltage to a thermal conductivity.

The heat capacity (cₚ) can be measured by:
activating the heating wire 8 with an alternating current (AC); and
measuring a phase and amplitude of the third harmonic of the measured alternating current (AC) voltage of the heating wire 8 during the heating of the portion 6 of the fluid with voltage measurement means 9 connected to the heating wire 8 and relating the measured phase and amplitude of the third harmonic of the measured AC voltage to a heat capacity.

A method for determining a thermal conductivity (κ) and a heat capacity (cₚ) of a fluid 1, whose flow is to be determined, is also provided, comprising:
contacting a thermal flow sensor 2 to a fluid flow 3;
measuring flow rate;
placing a thermal property sensor 4 in a measurement cavity 5 in fluid connection with, and preferably adjacent to, the fluid flow;
receiving the portion 6 of the fluid in the measurement cavity 5 of the thermal property sensor 4, in such a way, that the portion 6 of the fluid is essentially stationary in the measurement cavity 5,
heating a heating wire 8 of the thermal property sensor 4 with a constant current (DC) or very low frequency alternating current (AC), for heating the portion 6 of the fluid, and
measuring the voltage of the heating wire 8 during the heating of the portion 6 of the fluid with voltage measurement means 9 connected to the heating wire 8 and relating the measured voltage to a thermal conductivity;
heating the heating wire 8 of the thermal property sensor 4 with an alternating current (AC); and
measuring a phase and amplitude of the third harmonic of the measured alternating current (AC) voltage of the heating wire 8 during the heating of the portion 6 of the fluid with voltage measurement means 9 connected to the heating wire and relating the measured phase and amplitude of the third harmonic of the measured AC voltage to a heat capacity.

As shown in FIG. 6, the invention also relates to a method for producing an aforementioned thermal property sensor 4, wherein first, a support layer 22, preferably of 1 μm SiRN, is deposited on an Si wafer 25 by, for example, LPCVD (1). Then, a 20 nm Cr adhesion layer and 200 nm Pt layer 23 are deposited and etched by sputtering and IBE etching, respectively, to pattern the wires and metal traces (2, 3). The combination of Cr and Pt at these thicknesses gives excellent results, but other thicknesses and combinations metals are possible. The IBE etching step is performed twice with two different masks. The first step is for transferring the metal pattern, the second one to narrow the beam width and define the pattern in the SiRN support layer 22. In (4), SiRN is etched by plasma etching to open the window for etching the Si. All these steps are repeated for the backside of the wafer 25 to have wires 8, 14 on both sides (5-7). Finally, Si is etched by KOH (KOH 1:3 DI-water) to realize a cavity 5, 24 inside the wafer 25 between/around the wires 8, 14.

FIG. 7 shows an example embodiment of a flow channel 10 with a thermal flow sensor 2 and a thermal property sensor 4, wherein the flow sensing elements 14 may comprise probes. A pressure sensor 7 and an additional sensor 26 may be provided. The flow sensing elements 14 in the form of probes may be arranged at spaced-apart positions in the flow 3. The measurement cavity 5 with a heating wire 8 is also shown.

### LIST OF REFERENCE NUMERALS

1. Fluid
2. Thermal flow sensor
3. Fluid flow
4. Thermal property sensor
5. Measurement cavity
6. Stationary portion of the fluid
7. Pressure sensor
8. Heating wire
9. Voltage measurement means
10. Flow channel
11. Sensor body
12. Flow section
13. Flow sensing configuration
14. Flow sensing element
15. Main body portion
16. First body portion
17. Second body portion
18. Flow sensing wire
19. Chip
20. PCB
21. Wheatstone bridge
22. Layer of SiRN
23. Cr/Pt-layer
24. Flow sensing element cavity
25. Si wafer
26. Further sensor
27. Bond pad

1-19. (canceled)

20. A thermal flow sensor for determining a flow rate of a fluid, comprising:
a sensor body with a flow section, through which fluid flows in a flow direction during use,
a flow sensor configuration, comprising multiple flow sensing elements arranged at multiple locations in the flow section for measuring the flow velocity at different locations in the flow section,
wherein the multiple flow sensing elements are arranged parallel to each other in a plane parallel to the flow section, and wherein single flow sensing elements of the multiple flow sensing elements can be read out.

21. The thermal flow sensor according to claim 20, wherein the sensor body comprises:
a main body portion;
a first body portion extending from the main body portion;
a second body portion extending from the main body portion;
wherein the flow section is formed between the main body portion, the first body portion and the second body portion.

22. The thermal flow sensor according to claim 21, wherein the first body portion and the second body portion are parallel to each other.

23. The thermal flow sensor according to claim 20, wherein the parallel multiple flow sensing elements extend between the first body portion and the second body portion.

24. The thermal flow sensor according to claim 20, wherein the parallel multiple flow sensing elements are spaced-apart in the flow section in an even manner.

25. The thermal flow sensor according to claim 20, wherein each flow sensing element comprises a pair of flow sensing wires, or a combination of three flow sensing wires.

26. The thermal flow sensor according to claim 20, wherein the sensor body is a microelectromechanical device.

27. The thermal flow sensor according to claim 25, wherein the pairs of flow sensing wires are arranged parallel to each other.

28. The thermal flow sensor according to claim 25, wherein each of the one or more pairs of flow sensing wires forms a Wheatstone Bridge or part of a Wheatstone bridge.

29. The thermal flow sensor according to claim 20, comprising:
a measurement cavity for receiving a portion of the fluid, in such a way, that the portion of the fluid is essentially stationary in the measurement cavity, with a thermal property sensor comprising a heating wire configured for being heated with at least one of:
a constant current (DC) or very low frequency alternating current (AC), for heating the portion of the fluid, wherein the voltage of the heating wire during the heating of the portion of the fluid is measured with voltage measurement means connected to the heating wire, wherein the measured voltage is related to a thermal conductivity; and
a high frequency alternating current (AC), wherein a phase and amplitude of the third harmonic of the alternating current (AC) voltage of the heating wire during the heating of the portion of the fluid are measured with voltage measurement means connected to the heating wire, wherein the measured phase and amplitude of the third harmonic of the measured AC voltage are related to a heat capacity.

30. The thermal flow sensor according to claim 29, wherein the measurement cavity has a U- or V-shaped cross-section, wherein the heating wire is suspended in the measurement cavity with the U- or V-shaped cross-section.

31. The thermal flow sensor according to claim 20, wherein the thermal flow sensor is releasably inserted into a flow channel in which a fluid flow is present during use.

32. A method for determining a flow rate of a fluid independent of the thermal properties of the fluid comprising:
placing a thermal flow sensor according to claim 20 in a fluid flow;
placing a thermal property sensor in a measurement cavity in fluid connection with the fluid flow;
receiving a portion of the fluid in the measurement cavity of the thermal property sensor, in such a way, that the portion of the fluid is essentially stationary in the measurement cavity;
measuring at least one thermal property (κ, ρcₚ) of the fluid; and
compensating the measured flow rate for the at least one measured thermal property.

33. The method for determining at least one of a thermal conductivity (κ) and a heat capacity (cₚ) of a fluid, whose flow is to be determined, comprising:
placing a thermal flow sensor according to claim 20 in a fluid flow and measuring flow;
placing a thermal property sensor in a measurement cavity in fluid connection with the fluid flow;
receiving the portion of the fluid in the measurement cavity of the thermal property sensor, in such a way, that the portion of the fluid is essentially stationary in the measurement cavity, and at least one of
heating a heating wire of the thermal property sensor with a constant current (DC) or very low frequency alternating current (AC), for heating the portion of the fluid, and
measuring the voltage of the heating wire during the heating of the portion of the fluid with voltage measurement means connected to the heating wire and relating the measured voltage to a thermal conductivity; and
heating the heating wire of the thermal property sensor with a high frequency alternating current (AC); and
measuring a phase and amplitude of the third harmonic of the measured alternating current (AC) voltage of the heating wire during the heating of the portion of the fluid with voltage measurement means connected to the heating wire and relating the measured phase and amplitude of the third harmonic of the measured AC voltage to a heat capacity.

34. A thermal flow meter or controller, comprising a thermal flow sensor according to claim 20.

35. A use of the thermal flow meter or controller of claim 34 in a medical device.

36. The use of the thermal flow meter or controller according to claim 34 in a respiratory device.

37. A method for producing a thermal sensor flow sensor according to claim 20, comprising the steps of:
(1) depositing a support layer at both sides of a wafer,
(2) depositing a metal layer on one side of the wafer,
(3) patterning the metal layer,
(4) patterning the support layer to open windows for etching the Si underneath,
(5) repeating steps 2 to 4 on the other side of the wafer,
(6) etching the Si wafer to realize a U- or V-groove and a flow sensing element cavity inside the wafer.

38. The method according to claim 37, wherein:
(4) an SiRN support layer is etched to open the window for etching the Si wafer underneath.
